(19) United States
(12) Patent Application Publication
(10) Pub. No.: US 2006/0197670 A1
(43) Pub. Date: Sep. 7, 2006

(54) Method and associated device for personal weight control

(76) Inventor: Joan Breibart, New York, NY (US)

Correspondence Address: R. Neil Sudol, 714 Colorado Avenue, Bridgeport, CT, 06605, US

(21) Appl. No.: 11/064,629

(22) Filed: Feb. 24, 2005

(51) Int. Cl. G08B 23/00; G09B 19/00

(52) U.S. Cl. 340/573.1; 340/573.7; 434/127

(57) ABSTRACT

A weight control method utilizes a device for monitoring motion of a hand to a person's mouth. The user attaches the device at least in part the arm or hand used to during food consumption. The device is operated to detect each time that the person's hand approaches the person's mouth. The device automatically counts the times that the person's hand approaches the person's mouth and issues an alarm or alert signal once a predetermined count number has been attained.

### BACKGROUND OF THE INVENTION

The invention relates to personal weight control. More particularly, this invention relates to a method that a person may follow to limited the number of calories the person consumes on a daily basis. This invention also relates to an associated device that a person may use to assist him or her in a weight control program or method.

There have been a plethora of different programs to assist individuals in losing weight. Such programs frequently entail diets of one kind or another. Weight-control diets may be quite complicated as to the kinds of foods permitted and the amounts of those foods, as well as the times that the foods are consumed.

A more recent weight control approach has the individual limit the amount of food consumed by simply counting the bites that the individual takes during the course of a meal. Depending on how drastic the weight loss desired, the number of bites per meal may be limited, for example, to 12, 22, or 30,

A problem with this method is that individuals attempting to follow the method frequently lose count of the number of bites taken. Distractions such as social conversation may cause the individual to lose count. Concomitantly, should the individual persist in counting the bites he or she has taken, the individual may fail to partake in stimulating and entertaining repartee at the dinner table.

### OBJECTS OF THE INVENTION

It is an object of the present invention to provide a method and/or an associated device that facilitates the counting of bites during a meal.

Another object of the present invention is to provide such a method and/or device that is easy to use.

A further object of the present invention is to provide such a method and/or device that that may be unobtrusive to other people present during a meal.

A related object of the present invention is to provide such a device that may be camouflaged or disguised on the person of the user.

These and other objects of the present invention will be apparent from the drawings and descriptions herein. While every object is attained by one or more embodiments of the invention, there is not necessarily an embodiment that achieves all of the objects of the invention.

### SUMMARY OF THE INVENTION

A weight control method comprises, in accordance with the present invention, providing a device for monitoring motion of a hand to a person's mouth, attaching the device at least in part to an appendage of the person including an arm and a hand of the person; operating the device to detect each time that the person's hand approaches the person's mouth, further operating the device to automatically count the times that the person's hand approaches the person's mouth, and additionally operating the device to issue an alarm or alert signal once a predetermined count number has been attained.

The method may further comprise attaching at least a portion of the monitoring device to the person in a region encompassing the person's head, the person's neck and the person's upper torso. Pursuant to this feature of the invention, the monitoring device is a proximity detector that has two casing parts or carriers with elements of the sensing componentry on each part. One casing part is attached to the user's arm, for instance, around the wrist, and may be disguised as a bracelet or watch. The other casing part may be incorporated into a necklace, brooch, pendant, tie clip or tack, or may be hidden under the clothing close to the person's neck. As an example, where the proximity sensor is ultrasonic, one casing part contains an electro-acoustic transducer exemplarily in the form of a piezoelectric crystal, while the other casing or carrier part contains an acousto-electric transducer for sensing the emission of a signal from the electro-acoustic transducer.

The alarm or alert signal is preferably taken from the group consisting of an audible signal, a visual or optical signal, and a tactile signal.

The detecting of a “bite” motion of an arm or hand may be accomplished in accordance with the present invention by detecting a motion of the person's appendage. This is achieved in turn by operating an acceleration sensor.

A weight control device in accordance with the present invention comprises at least one casing, a coupling element such as a wrist band for attaching the casing to an appendage of a person (an arm or hand), a monitor or sensor mounted at least in part to the casing for sensing each time that the person's hand approaches the person's mouth, a counter operatively connected to the monitor or sensor for automatically counting the times that the person's hand approaches the person's mouth, and an indicator operatively connected to the counter for issuing an alarm signal once a predetermined count number has been attained.

Where the monitor or sensor is a proximity detector, the device further comprises a second casing and a coupling element such as a necklace or pin for attaching the second casing to the person in a region about the person's head, such as at the person's neck or upper torso.

The proximity detector is preferably taken from the group consisting of a magnetic sensor, an ultrasonic sensor, a photocell, an infrared radiation detector, and a radio wave detector. In each case, the detector includes at least one component attached to the user's arm or hand via the one casing and another component attached to the person of the user about the head, exemplarily around the neck or on the chest. In the case of an ultrasonic sensor, an electro-acoustic transducer (speaker) exemplarily in the form of a piezoelectric crystal is attached to the wrist or about the neck region, while a pickup element in the form of an acousto-electric transducer is attached to the user at the neck region or the wrist area. In the case of a photocell, infrared radiation detector or radio wave receiver, an emitter of radiation is located on the user via one casing, while a radiation receiver is attached to the user via the other casing. In the event that the proximity detector is magnetic, one casing contains a permanent magnet or an electromagnet, while the other contains an electromagnet.

The indicator or alarm signal generator may be an electroacoustic transducer for generating an audible atmospheric pressure wave, an electro-optical transducer for generating a light flash, or a vibrator of buzzing the user's skin surface.

Instead of a proximity detector, the monitor or sensor may include an acceleration detector such as a gravity switch. This sensor is preferably attached to the user at the wrist (or to a finger ring) to maximize the acceleration produced during normal eating motions.

As another alternative, the monitor or sensor may include a strain detector. Such a sensor would best be disposed in an elbow band with strain gauges located along the outside surface. The strain gauge elements detect stretching due to the bending of the elbow when the hand is raised to the wearer's lips.

### BRIEF DESCRIPTION OF THE DRAWINGS

FIG. 1 is generally a block diagram of a device for monitoring motions of a person's arm particularly towards the person's mouth, to count bites that the person takes, in accordance with the present invention.

FIG. 2 is a block diagram showing a set of components of the device of FIG. 1, pursuant to one particular embodiment of the present invention.

FIG. 3 is a block diagram showing components of the device of FIG. 1, pursuant to another particular embodiment of the present invention.

FIG. 4 is a block diagram showing components of the device of FIG. 1, pursuant to a further particular embodiment of the present invention.

FIG. 5 is a block diagram showing components of the device of FIG. 1, pursuant to an additional particular embodiment of the present invention.

FIG. 6 is a block diagram showing components of the device of FIG. 1, pursuant to yet another particular embodiment of the present invention.

FIG. 7 is a block diagram showing components of the device of FIG. 1, pursuant to yet a further particular embodiment of the present invention.

### DEFINITIONS

The term “monitoring motion of a person's hand” is intended herein to encompass any way of determining that a person's hand has moved to the person's mouth. Pursuant to the weight control object of the invention, the motion is monitored during a meal to measure the amount of food that the individual has consumer. Each motion of the hand to the mouth is considered a “bite” and the weight control method contemplates that the individual will allow himself or herself only a given number of bites per meal. Monitoring the motion of the hand may be accomplished in different ways, such as by a acceleration detector (e.g., gravity switch) attached to the person's wrist. Alternatively, a strain gauge at the person's elbow can detect when the elbow is bent an amount normally experienced when the person brings a food utensil to his or her mouth. Another alternative is a proximity detector that senses when the hand is brought within a predetermined distance of the mouth.

The term “alarm signal” or “alert signal” is used herein to designate any sort of energy that may be sensed by an individual user. Thus, an alarm or alert signal pursuant to the present disclosure may include a beeping or buzzing sound, a musical melody, a word message, an electric shock, a light flash, a vibration, or even a fragrance.

The term “attach” and variants thereof, where used herein to describe the coupling of a sensing device to the individual, may encompass an attachment via person's hand

### DETAILED DESCRIPTION

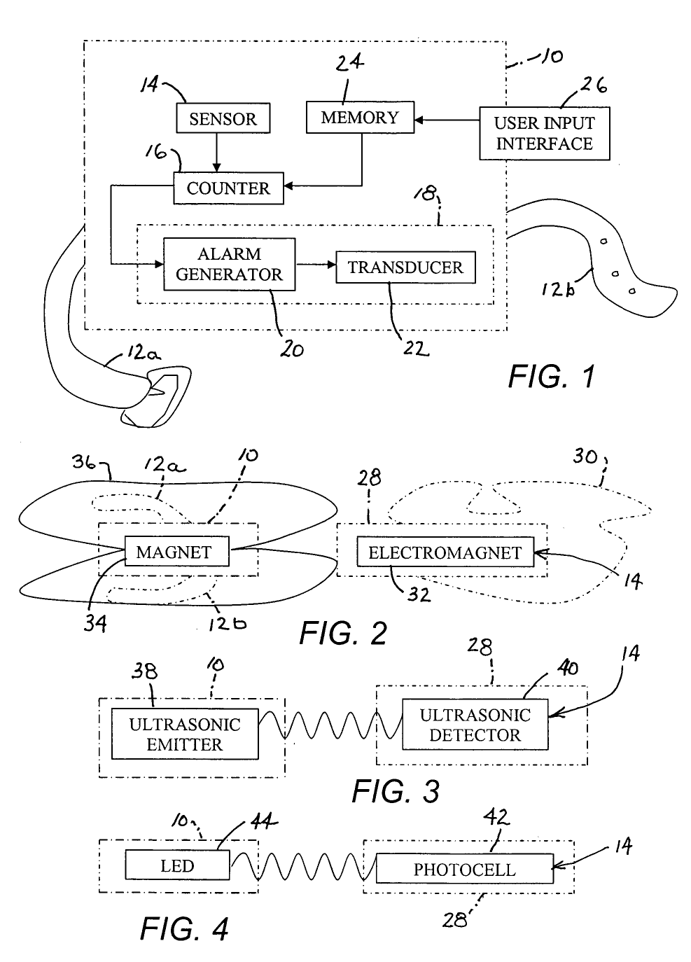

FIG. 1 illustrates a device for assisting a user in a weight control method wherein the user terminates a feeding activity after having eaten a predetermined number of bits of comestible materials. The device comprises a casing 10, a coupling element such as a wrist band 12a, 12b for attaching the casing to an appendage such as an arm or a hand (not shown), and a monitor or sensor 14 mounted at least in part to the casing for sensing each time that the person's hand approaches the person's mouth. Sensor 14 can takes any form that is able to detect a feeding action of the individual, that is, an action involving the transport of food to the person's mouth. Thus sensor 14 may detect arm or hand motion per se or may detect proximity of an arm or hand to the person's head region.

As further illustrated in FIG. 1, the bite-monitoring device further includes a counter 16 disposed in casing 10 and operatively connected to monitor or sensor 14 for automatically counting the times that the user's hand approaches his or her mouth. Counter 16 is operatively connected to an indicator 18 for inducing the indicator to issue an alarm signal once a predetermined count number has been attained.

Indicator 18 typically includes an electrical signal generator 20 and a transducer 22 that converts the electrical signal into an alarm signal that can be sensed by the individual user. Transducer 22 may be an electromechanical transducer such as a piezoelectric crystal that converts an AC electrical signal into a sound-frequency atmospheric disturbance. Alternatively, transducer 22 may be an electromechanical transducer such as an eccentric rotating weight that converts an AC electrical signal into a vibration that may be apprehended through tactile sensation. In another alternative configuration, transducer 22 may be a light-emitting diode or other electro-optical device that generates a visible signal.

As further illustrated in FIG. 1, the weight control assist device includes a memory 24 and a user input or interface 26 for modifying the predetermined count threshold of counter 16, thus enabling the user to change the number of permissible bites of food. Interface 26 and memory 24 may also be used to reset the counter 16 after the counter has reached the preset number of bites.

Where monitor or sensor 14 takes the form of a proximity detector, exemplarily shown in FIG. 2, the weight control assist device further comprises a second casing 28 and a coupling element 30 such as a necklace or pin for attaching the second casing to the person in a region about the person's head, such as at the person's neck or upper torso. In the event that monitor or sensor 14 is a proximity detector, various components of FIG. 1 may be disposed in casing 28 rather than casing 10. Particularly where the alarm or alert signal produced indicator 18 takes the form of an audible signal or a tactile signal, casing 28 is a suitable choice for holding counter 14, alarm generator 20 and transducer 22. Memory 24 and user input or interface 26 may additionally be disposed on casing 28. If, however, one or more components are disposed on casing 10 and one or more components on casing 28, then a supplemental wireless information link may be used to enable communication between the spaced components.

As depicted in FIG. 2, sensor 14 takes the form of a magnetic sensor such as an electromagnet 32 that is disposed in casing 10 or 28 and a permanent magnet 34 disposed in the other casing 28 or 10. Electromagnet 32 senses the proximity of magnet 34 via the magnetic field 36 thereof. Each time there is a new or renewed detection of a magnetic field, electromagnet 32 feeds a count incrementing signal to counter 16.

FIG. 3 shows another form of a proximity sensor 14 comprising an ultrasonic waveform generator or emitter 38 and an ultrasonic waveform detector or receiver 40. Emitter 38 is disposed on casing 10 or 28, while detector 40 is disposed on the other casing 28 or 10. Emitter 38 generates an atmospheric pressure wave of an ultrasonic frequency that is picked up by detector 40 only when the detector is within a predetermined range of emitter 38. Each time detector 40 senses ultrasonic waveform energy anew, the detector feeds a count incrementing signal to counter 16. Of course, detector 40 may be designed to detect a predetermined waveform such as a pulsed waveform of a certain beat, in order to obviate the counting of spurious ultrasonic pressure waves.

As shown in FIG. 4, sensor 14 as a proximity detector may include a photocell 42 mounted preferably to casing 10 and a radiation emitter such as a light emitting diode (LED) 44 preferably mounted to casing 28. In the case of optical radiation, the light generated by LED 44 is preferably low level and not detectible by casual inspection.

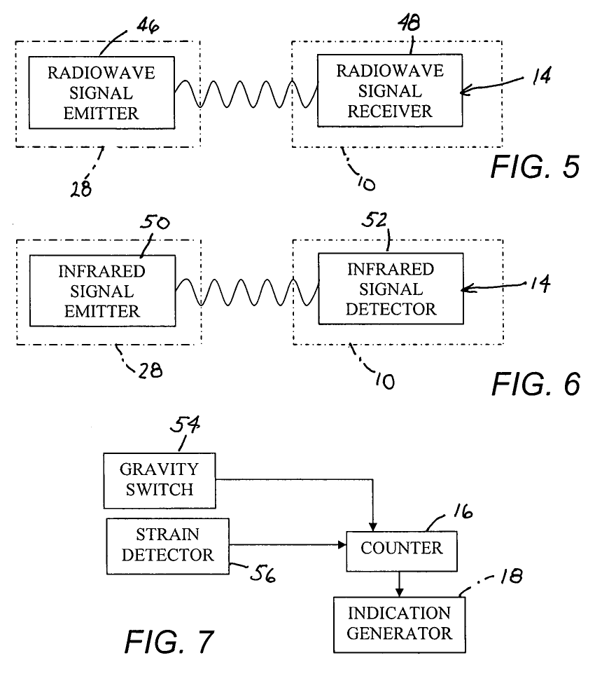

Preferably, where electromagnetic waveform energy is used as the communication medium in a proximity sensor or detector 14, the radiation has a wavelength outside the range of the optical spectrum. Accordingly, as illustrated in FIG. 5, sensor 14 as a proximity detector may include a radio-frequency signal emitter 46 mounted to casing 10 or 28 (preferably 28) and a radio-frequency signal receiver 48 mounted to casing 28 or 10 (preferably 10). Emitter 46 generates electromagnetic radiation of a radio-wave frequency that is picked up by receiver 48 only when the receiver is within a predetermined range of emitter 46. Each time receiver 48 senses waveform energy anew, the receiver feeds a count incrementing signal to counter 16. Of course, emitter 46 and receiver 48 may communicate only via a predetermined waveform, modulated, for instance, in order to obviate the counting of spurious radio-frequency waves.

As shown in FIG. 6, sensor 14 as a proximity detector may include an infrared signal emitter 50 mounted to casing 10 or 28 (preferably 28) and an infrared signal detector 52 mounted to casing 28 or 10 (preferably 10). Emitter 50 generates electromagnetic radiation of an infrared frequency that is picked up by detector 52 only when the detector is within a predetermined range of emitter 50. Each time detector 52 senses infrared waveform energy anew, the detector feeds a count incrementing signal to counter 16. Of course, emitter 50 and detector 52 may communicate only via a predetermined waveform, which may be modulated for identification purposes in order to obviate the counting of spurious infrared energy, emitted, for instance, by the body of the user.

In each case that sensor takes the form of a proximity detector, at least one component is attached to the user's arm or hand via the one casing 10 and another component attached to the person of the user about the head, exemplarily around the neck or on the chest.

As depicted in FIG. 7, sensor 14 may include an acceleration detector or gravity switch 54 or a strain gauge 56. Acceleration detector or gravity switch 54 is preferably attached to the user at the wrist (or to a finger ring) to maximize the acceleration produced during normal eating motions. Strain gauge 56 may be disposed in an elbow band (not specifically shown) with strain gauge elements (e.g., current-carrying wires) located along an outside surface. The strain gauge elements detect stretching due to the bending of the elbow when the hand is raised to the wearer's lips.

A weight control method utilizing the above-described device includes an automatic monitoring of a person's eating movement, particularly the movement of food to the user's mouth during an eating process such as at mealtime. Casing 10 of the device is attached at least in part to an arm or hand of the person via wrist band 12a, 12b. The device is operated to detect each time that the person's hand approaches the person's mouth. Counter 16 automatically counts the times that the user's hand approaches his or her mouth, and induces indicator 18 to issue an alarm or alert signal once a predetermined count number has been attained.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. A weight control method comprising:
providing a device for monitoring motion of a hand to a person's mouth;
attaching said device at least in part to an appendage of the person including an arm and a hand of the person;
operating said device to detect each time that the person's hand moves toward the person's mouth;
further operating said device to automatically count the times that the person's hand moves toward the person's mouth; and
additionally operating said device to provide a numerical indication to the person.

2. The method defined in claim 1, further comprising attaching at least a portion of said device to the person in a region encompassing the person's head, the person's neck and the person's upper torso.

3. The method defined in claim 2 wherein the operating of said device to detect each time that the person's hand approaches the person's mouth comprises detecting proximity of the person's hand to the person's mouth.

4. The method defined in claim 19 wherein said alarm signal is taken from the group consisting of an audible signal, a visual or optical signal, and a tactile signal.

5. The method defined in claim 1 where the operating of said device to detect each time that the person's hand approaches the person's mouth comprises detecting a motion of the person's appendage.

6. A weight control device comprising:
at least one casing;
means for attaching said casing to an appendage of a person, said appendage consisting of an arm and a hand of the person;
monitoring means mounted at least in part to said casing for sensing each time that the person's hand moves toward the person's mouth;
counting means operatively connected to said monitoring means for automatically counting the times that the person's hand moves toward the person's mouth; and
indicator means operatively connected to said counting means for providing a numerical indicator.

7. The device defined in claim 6 wherein said casing is a first casing, further comprising a second casing and means for attaching said second casing to the person in a region encompassing the person's head, the person's neck and the person's upper torso.

8. The device defined in claim 7 wherein said monitoring means includes a proximity detector.

9. The device defined in claim 6 wherein said monitoring means includes a device taken from the group consisting of a magnetic sensor, an ultrasonic sensor, a photocell, an infrared radiation detector, and a radio wave receiver.

10. The device defined in claim 7 wherein said monitoring means includes a component mounted to said second casing.

11. The device defined in claim 7 wherein said counting means and said indicator means are each mounted to a respective one of said first casing and said second casing.

12. The device defined in claim 6 wherein said indicator means is taken from the group consisting of an electroacoustic transducer, an electro-optical transducer, and a vibrator.

13. The device defined in claim 6 wherein said monitoring means includes an acceleration detector.

14. The device defined in claim 6 wherein said monitoring means includes a strain detector.

15. A weight control device comprising:
at least one casing attachable to an appendage of a person, said appendage consisting of an arm and a hand of the person;
sensing componentry mounted at least in part to said casing, said sensing componentry being taken from the group consisting of a proximity sensor, an acceleration detector, and a strain sensor;
a counter operatively connected to said sensing componentry for automatically counting the times that the person's hand moves toward the person's mouth; and
an indicator or communications element operatively connected to said counter for providing feedback to the person.

16. The device defined in claim 15 wherein said casing is a first casing, further comprising a second casing attachable to the person in a region encompassing the person's head, the person's neck and the person's upper torso.

17. The device defined in claim 15 wherein said sensing componentry is taken from the group consisting of a magnetic sensor, an ultrasonic sensor, a photocell, an infrared radiation detector, and a radio wave receiver.

18. The device defined in claim 15 wherein said indicator or communications element is taken from the group consisting of an electroacoustic transducer, an electro-optical transducer, and a vibrator.

19. The method defined in claim 1 wherein operating the device to provide a numerical indication to the person includes issuing an alarm signal once a predetermined number has been attained.

20. The device defined in claim 6 wherein said indicator means is operatively connected to said counting means for issuing an alarm signal indicating that a predetermined numerical amount has been attained.

21. A weight control method comprising:
providing a device for monitoring a person's feeding action during a meal;
attaching said device at least in part to an arm or hand of the person;
operating said device to detect an action involving transport of food to the person's mouth;
further operating said device to automatically count the times that the person transports food to the mouth; and
additionally operating said device to provide a numerical indication to the person.

22. The method defined in claim 21 wherein operating the device to provide a numerical indication to the person includes issuing generating an audible signal, a visual or optical signal, and a tactile signal.
